(19) United States
(12) Patent Application Publication
(10) Pub. No.: US 2009/0213271 A1
(43) Pub. Date: Aug. 27, 2009

(54) Video Signal Processing Device and Video Signal Processing Method

(75) Inventor: Hirotoshi Miyazawa, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/333,963

(22) Filed: Dec. 12, 2008

(30) Foreign Application Priority Data
Feb. 25, 2008 (JP) 2008-043106

(51) Int. Cl. H04N 5/14; H04N 9/77

(52) U.S. Cl. 348/672; 348/712; 348/E05.001

(57) ABSTRACT

According to one embodiment, an extraction module that extracts a high frequency component of a luminance signal, an acquisition module that acquires band histogram data according to amplitude levels with respect to one frame from the high frequency component of the luminance signal, a control module that applies gain control for contour correction processing based on a gain value provided from outside to the luminance signal, and a generation module that generates a gain value to be provided to the control module on the basis of the acquired band histogram data are included.

### CROSS-REFERENCE TO RELATED APPLICATIONS

This application is based upon and claims the benefit of priority from Japanese Patent Application No. 2008-043106, filed Feb. 25, 2008, the entire contents of which are incorporated herein by reference.

### BACKGROUND

1. Field

One embodiment of the invention relates to improvements of a video signal processing device and a video signal processing method in which contour correction processing is applied to a luminance signal on the basis of a luminance histogram.

2. Description of the Related Art

As is well known, in recent years, a large screen display of a flat panel type has been developed, and has been used in practice for a color television broadcast receiving device and the like. Then, a large screen display of this type applies contour correction processing to a luminance component of a video signal in order to show display video clearly.

As such contour correction processing applied to a luminance component, there has been known a method of correcting a contour in accordance with distribution in a luminance histogram of an input video signal. A basic concept of this method is to generate a histogram of luminance levels with respect to video of one screen, and to vary levels of contour components of a luminance signal based on the luminance histogram.

The above contour correction means is still in a stage in the middle of development, and generates situations where a contour correction effect is generated excessively, and, on the contrary, a contour correction effect is weak at a necessary section, and the like, with respect to a video source of various kinds of pictures in these days. Therefore, the above contour correction means is not sufficiently suitable for practical use under the present circumstances.

Jpn. Pat. Appln. KOKAI Publication No. 2006-013735 discloses a configuration of a video display device that extracts contour components of an input video signal by using a filter circuit, and then controls contour emphasis amounts of a contour component nonlinear processing module that varies amplitudes of contour components in accordance with a histogram of the extracted contour components, and adds an output of the contour component nonlinear processing module and the input video signal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block configuration view showing an example of the present invention shown for explanation of a video signal processing system of a television broadcast receiving device;

FIG. 2 is a block configuration view shown for explanation of a detail of a video signal processing module of the television broadcast receiving device in the same example;

FIG. 3 is a block configuration view shown for explanation of an example of a signal correction module of the video signal processing module in the same example;

FIG. 4 is a view shown for explanation of operation of a band histogram acquisition module of the signal correction module in the same example;

FIG. 5 is a view shown for explanation of band histogram data generated by the signal correction module in the same example;

FIG. 6 is a flowchart shown for explanation of an example of processing operation carried out by an analysis control module of the signal correction module in the same example;

FIG. 7 is a view shown for explanation of an example of a table used when the analysis control module of the signal correction module in the same example carries out processing operation;

FIG. 8 is a block configuration view shown for explanation of an example of another signal correction module of the video signal processing module in the same example;

FIG. 9 is a view shown for explanation of luminance histogram data generated in the another example of the signal correction module in the same example; and

FIG. 10 is a flowchart shown for explanation of an example of processing operation carried out by the analysis control module shown by the another example of the signal correction module in the same example.

### DETAILED DESCRIPTION

Various embodiments according to the invention will be described hereinafter with reference to the accompanying drawings. In general, according to one embodiment of the invention, an extraction module that extracts a high frequency component of a luminance signal, an acquisition module that acquires band histogram data according to amplitude levels with respect to one frame from the high frequency component of the luminance signal, a control module that applies gain control for contour correction processing based on a gain value provided from outside to the luminance signal, and a generation module that generates a gain value to be provided to the control module on the basis of the acquired band histogram data are included.

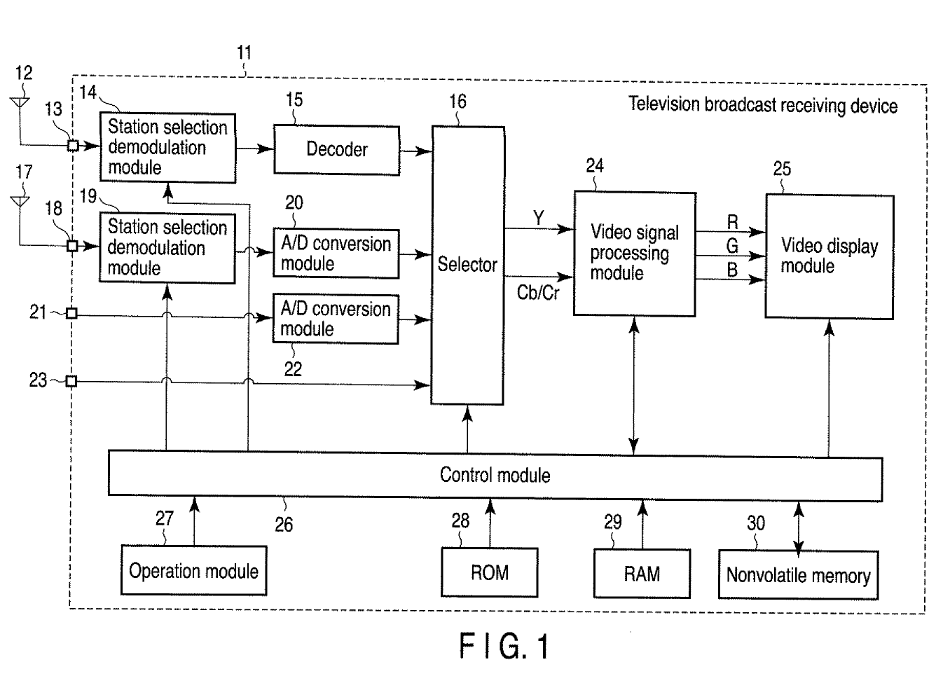

FIG. 1 schematically shows a video signal processing system of a television broadcast receiving device 11 described in this example.

That is, a digital television broadcast signal received by using an antenna 12 for receiving digital television broadcast is supplied to a station selection demodulation module 14 through an input terminal 13. The station selection demodulation module 14 selects a broadcast signal of a desired channel from the input digital television broadcast signal, and demodulates the selected signal and outputs the demodulated signal to a decoder 15.

Then, the decoder 15 generates a digital luminance signal Y and a digital color signal Cb/Cr by applying decoding processing to the signal input from the station selection demodulation module 14, and outputs the generated signals to a selector 16.

In addition, an analog television broadcast signal received by using an antenna 17 for receiving analog television broadcast is supplied to a station selection demodulation module 19 through an input terminal 18. The station selection demodulation module 19 selects a broadcast signal of a desired channel from the input analog television broadcast signal, and generates an analog luminance signal Y and an analog color signal Cb/Cr by demodulating the selected signal.

Then, the analog luminance signal Y and the analog color signal Cb/Cr generated at the station selection demodulation module 19 are supplied to an analog/digital (A/D) conversion module 20 to be converted to a digital luminance signal Y and a digital color signal Cb/Cr, and then output to the selector 16.

In addition, the analog luminance signal Y and the analog color signal Cb/Cr supplied to an external input terminal 21 for analog video signals are supplied to an analog/digital (A/D) conversion module 22 to be converted to a digital luminance signal Y and a digital color signal Cb/Cr, and then output to the selector 16. Further, a digital luminance signal Y and a digital color signal Cb/Cr supplied to an external input terminal 23 for digital video signals are supplied to the selector 16 as they are.

Here, the selector 16 selects one set of the digital luminance signal Y and the digital color signal Cb/Cr from those supplied from the decoder 15, the A/D conversion modules 20 and 22, and the external input terminal 23, and supplies the one set of the signals to a video signal processing module 24.

The video signal processing module 24 generates red (R), green (G), and blue (B) signals by applying predetermined signal processing to the input digital luminance signal Y and digital color signal Cb/Cr. Details of such generation will be described later.

Then, the R, G, and B signals generated at the video signal processing module 24 are supplied to a video display module 25 and is used for video display. As the video display module 25, for example, a flat panel display including a surface electric field display, a liquid crystal display, plasma display, and the like is adopted.

Here, a variety of operations including the above receiving operation of the television broadcast receiving device 11 is subject to centralized control by a control module 26. The control module 26 is a microprocessor that includes a central processing unit (CPU) and the like, and receives operation information from an operation module 27 including a remote controller (not shown) and controls each module so that a content of such operation is reflected.

In this case, the control module 26 mainly uses a read only memory (RUM) 28 that stores a control program executed by the CPU, a random access memory (RAM) 29 that provides a work area to the CPU, and a nonvolatile memory 30 that stores variety of setting information, control information, and the like.

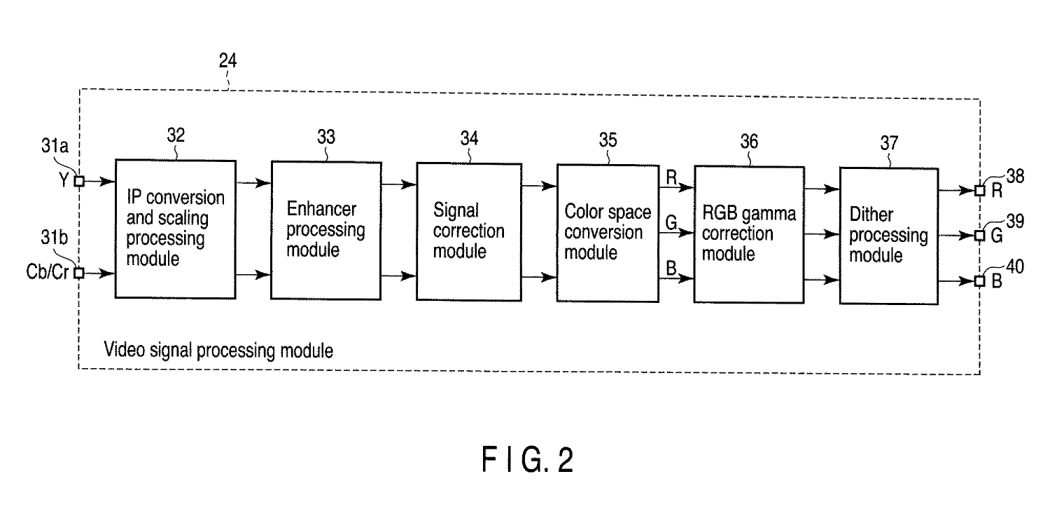

FIG. 2 shows an example of the video signal processing module 24. That is, the digital luminance signal Y and the digital color signal Cb/Cr selected by the selector 16 are supplied to an interlace progressive (IP) conversion and scaling processing module 32 through input terminals 31a and 31b.

The IP conversion and scaling processing module 32 applies progressive conversion processing and scaling processing to the input luminance signal Y and color signal Cb/Cr so that the signals are displayed on the video display module 25 (a flat panel display including a surface electric field display, a liquid crystal display, a plasma display, and the like), and outputs the signals to an enhancer processing module 33.

The enhancer processing module 33 applies enhancer processing to the input luminance signal Y and color signal Cb/Cr, so that rising edges in vertical and horizontal directions are made rapid, or sharpness is changed. Then, the enhancer processing module 33 outputs the signals to a signal correction module 34.

The signal correction module 34 applies contour correction processing to the input luminance signal Y, and also applies amplitude control processing to the color signal Cb/Cr along the contour correction processing, and outputs the signals to a color space conversion module 35.

The color space conversion module 35 converts the input luminance signal Y and color signal Cb/Cr to R, G, and B signals, and outputs the signals to an RGB gamma correction module 36. The RGB gamma correction module 36 applies white balance adjustment to the input R, G, and B signals, and also applies gamma correction processing with respect to the video display module 25, and outputs the signals to a dither processing module 37.

Then, after the dither processing module 37 applies compression processing to the input R, G, and B signals so that a bit expression with high gradation with expanded bit numbers for increasing expressive power is converted to a bit number with low gradation corresponding to the video display module 25. Then, the dither processing module 37 outputs the signals to the video display module 25 through output terminals 38, 39, and 40.

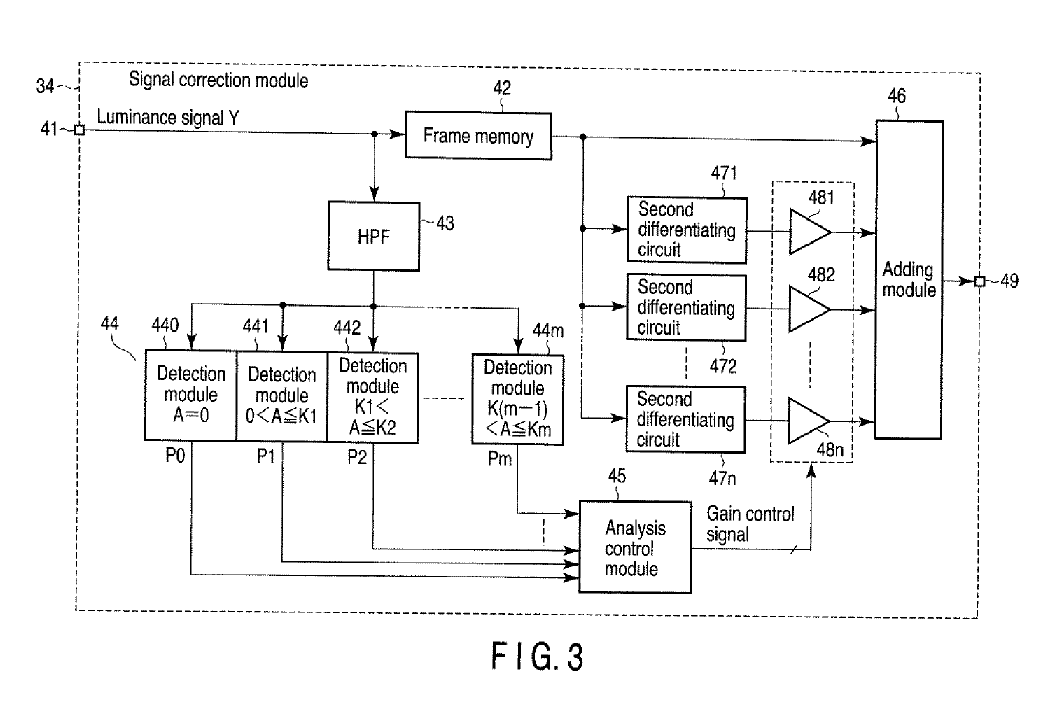

FIG. 3 shows an example of a section that applies the contour correction processing to the luminance signal Y in the signal correction module 34. That is, the luminance signal Y output from the enhancer processing module 33 passes through an input terminal 41, and then the luminance signal Y is supplied to a high pass filter (HPF) 43 after one frame of the signal is retained in a frame memory 42.

The HPF 43 is set to allow a high definition band component to pass from the input luminance signal Y. In this manner, an output of the HPF 43 has a high amplitude level when a frequency band of the input luminance signal Y is high, and the amplitude level becomes lower as the frequency band of the input luminance signal Y becomes lower. When a direct current component is input, the amplitude level becomes 0.

Then, the output of the HPF 43 is supplied to band histogram acquisition modules 44 classified by amplitude levels. The band histogram acquisition modules 44 acquires band histogram data by counting pixels of a band output from the HPF 43 according to amplitude levels with respect to one frame of the luminance signal Y.

More specifically, when an amplitude level of an output of the HPF 43 is A, the band histogram acquisition modules 44 includes a detection module 440 that counts the number of pixels P0 at A=0, a detection module 441 that counts the number of pixels P1 at 0<A≦K1, a detection module 442 that counts the number of pixels P2 at K1<A≦K2, . . . , and a detection module 44m that counts the number of pixels Pm at K(m−1)<A ≦Km. The band histogram acquisition modules 44 outputs count results of the detection modules 440 to 44m to an analysis control module 45 as band histogram data.

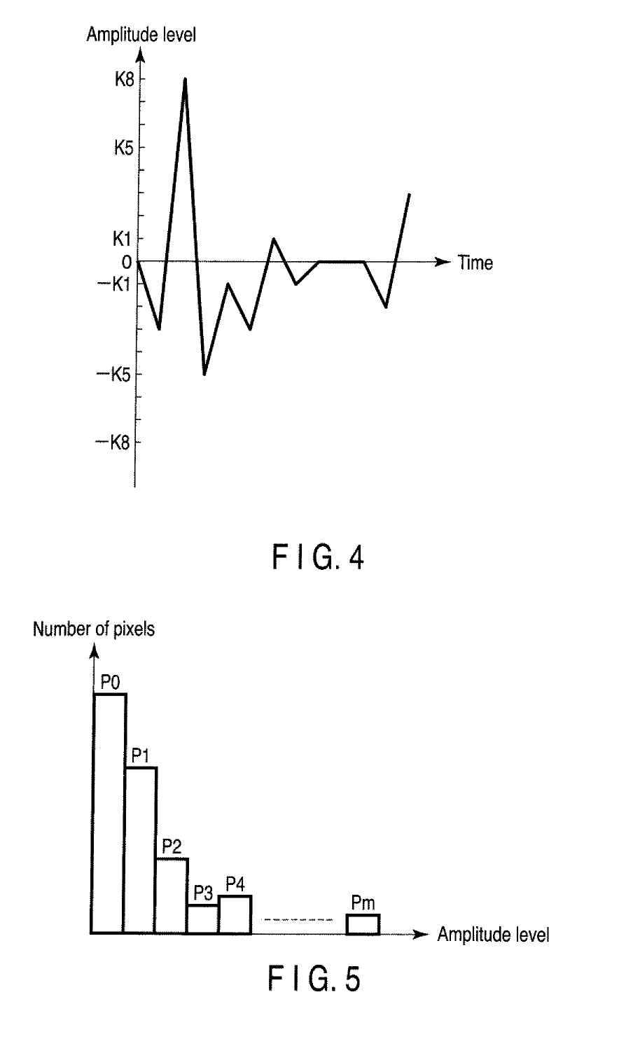

In this case, an output of the HPF 43 is alternating current, and has positive and negative amplitude levels as shown in FIG. 4. However, the detection modules 440 to 44m of the band histogram acquisition modules 44 discriminate the amplitude levels in absolute values to count the numbers of pixels P0 to Pm.

In the above manner, as shown in FIG. 5, band histogram data showing the numbers of pixels P0 to Pm according to amplitude levels can be acquired with respect to high frequency components of one frame of the luminance signal Y output from the HPF 43. For this reason, the analysis control module 45 can discriminate signals of what frequency bands a video frame as a target of the contour correction processing is configured of.

On the other hand, description will be made with reference to FIG. 3 again, and the one frame of the luminance signal Y retained in the frame memory 42 is supplied to an adding module 46, and also supplied to each of a plurality of second differentiating circuits 471, 472, . . . 47n. The second differentiating circuits 471 to 47n are filters that extract high frequency components from the luminance signal Y, and have passband frequencies different from each other.

In this case, passband frequencies of the second differentiating circuit 471 is the lowest, passband frequencies sequentially become higher in the second differentiating circuits 472, 473, . . . in this order, and passband frequencies of the second differentiating circuit 47n is set to be the highest. Part of passband frequencies of the second differentiating circuit 471 to 47n may be or may be not overlapping passband frequencies of the HPF 43.

Then, high frequency components of the luminance signal Y output from the second differentiating circuits 471 to 47n are supplied to respective gain control modules 481, 482, . . . , 48n. The gain control modules 481 to 48n apply gain control based on gain control signals supplied from the analysis control module 45 to the outputs of respective second differentiating circuits 471 to 47n, and output results to the adding module 46.

In this case, the analysis control module 45 generates gain control signals to be provided to the gain control modules 481 to 48n on the basis of band histogram data acquired at the band histogram acquisition modules 44. That is, the gain control modules 481 to 48n apply gain control independently based on the gain control signal generated individually to the high frequency components of the luminance signal Y extracted by the respective second differentiating circuits 471 to 47n.

Then, the adding module 46 adds outputs of the gain control modules 481 to 48n to the luminance signal Y supplied from the frame memory 42. In this manner, the contour correction processing is applied to the luminance signal Y, and the luminance signal Y applied with the contour correction processing in this manner is output to the color space conversion module 35 through an output terminal 49.

The frame memory 42 has a function of delaying supply of the luminance signal Y to the second differentiating circuit 471 to 47n for a period of processing time in the analysis control module 45. In this manner, gain control based on the gain control signals in the gain control modules 481 to 48n is properly carried out at a timing corresponding to the luminance signal Y at the time that the gain control signals are generated.

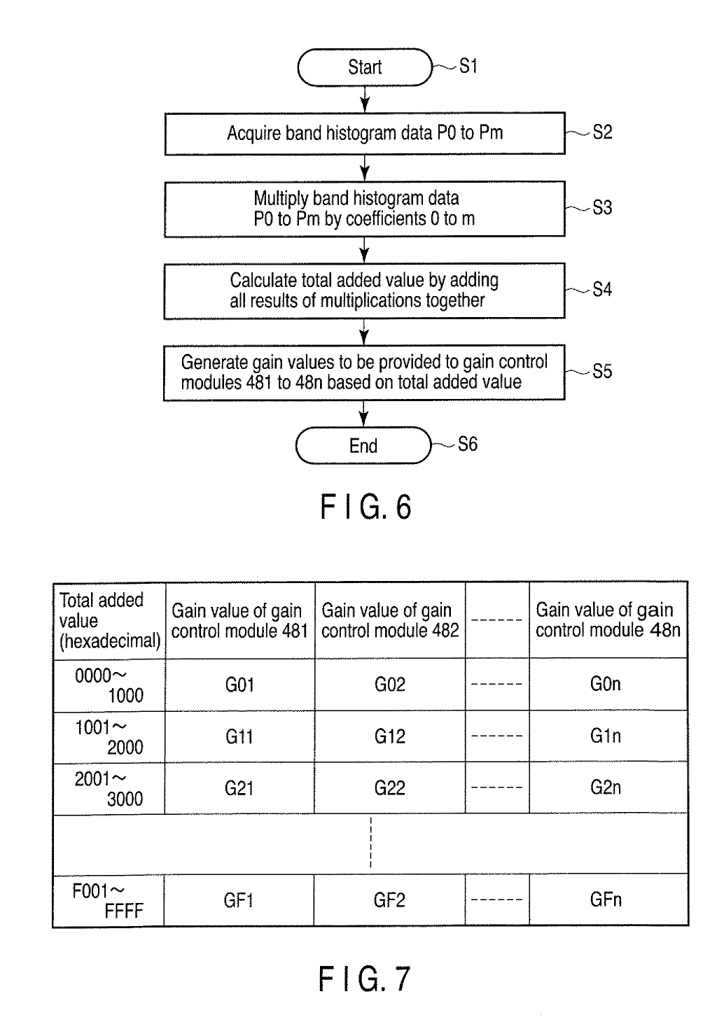

FIG. 6 shows a flowchart that organizes an example of processing operation in which the analysis control module 45 generates gain control signals to be provided to the gain control modules 481 to 48n on the basis of the band histogram data acquired by the band histogram acquisition modules 44. That is, when the processing starts (Step S1), the analysis control module 45 acquires band histogram data (the numbers of pixels P0 to Pm) from the detection modules 440 to 44m of the band histogram acquisition modules 44 in Step S2.

Then, in Step S3, the analysis control module 45 multiplies the band histogram data P0 to Pm acquired previously by coefficients set in advance. As the coefficients, for example, 0, 1, 2, . . . , m are set corresponding to the band histogram data P0, P1, P2, . . . , Pm. In this manner, multiplication processing of P0×0, P1×1, P2×2, . . . , Pm×m, that is, processing of reducing band histogram data corresponding to lower amplitude levels and increasing band histogram data corresponding to higher amplitude levels, is carried out. After the above, in Step S4, the analysis control module 45 calculates a total added value by adding results of all multiplications of the band histogram data P0 to Pm and corresponding coefficients 0 to m together.

Next, in Step S5, the analysis control module 45 generates gain values to be provided to the gain control modules 481 to 48n based on a result of the total added value. Then, the analysis control module 45 supplies the generated gain values to the gain control modules 481 to 48n as the gain control signals described above, and the processing ends (Step S6).

In this case, as shown in FIG. 7, relationships between the total added value of all the results of multiplications between the band histogram data PC to Pm and the coefficients 0 to m and the gain values to be provided to the gain control modules 481 to 48n are organized in a table in advance and stored in the ROM 28 and the like. Then, when the analysis control module 45 calculates the total added value of all the results of multiplications between the band histogram data P0 to Pm and the coefficients 0 to m, the analysis control module 45 reads the gain values to be provided to the gain control modules 481 to 48n corresponding to the total added value from the table. Then, the analysis control module 45 generates gain control signals showing the gain values read out from the table, and supplies the gain control signals to the corresponding gain control modules 481 to 48n.

Here, in case the total added value calculated by adding results of all multiplications between the band histogram data P0 to Pm and the coefficients 0 to m together is small, an entire frequency band of the luminance signal Y is determined to be low, that is, a contour is determined to be unclear. For this reason, a gain value to be provided to the gain control module 481 that is supplied with an output of the second differentiating circuit 471 with the lowest passband frequencies is set to be the highest, gain values to be provided to the gain control modules 482, 483, . . . , are set to be lower sequentially in this order, and a gain value to be provided to the gain control module 48n supplied with an output of the second differentiating circuit 47n with the highest passband frequencies is set to be the lowest.

In addition, in case the total added value calculated by adding results of all multiplications between the band histogram data P0 to Pm and the coefficients 0 to m together is large, an entire frequency band of the luminance signal Y is determined to be high, that is, a contour is determined to be clear. In this case, the gain values themselves are set to be lower by maintaining magnitude correlation between the gain values to be provided to the gain control modules 481 to 48n, so as to prevent excessive contour correction.

According to the example described above, a band histogram data showing the numbers of pixels P0 to Pm according to amplitude levels is acquired based on high frequency components of the luminance signal Y extracted by the HPF 43. Since the band histogram data corresponds to frequency bands of the luminance signal Y, gain values for applying the contour correction processing to the luminance signal Y can be set on the basis of the band histogram data. In this manner, a contour correction effect of certain quality can be generated all the time with respect to video of a variety of pictures.

In addition, only one of the HPF 43 is used as a filter in order to acquire a band histogram from the luminance signal Y. Accordingly, a configuration is simple and is sufficiently suitable for practical use.

Further, gain control is applied to high frequency components of the luminance signal Y output from a plurality of the second differentiating circuits 471 to 47n with passband frequencies different from each other by using gain values generated based on band histogram data by the corresponding gain control modules 481, 482, . . . , and 48n. Accordingly, a contour correction effect of certain quality can be generated all the time with respect to video of a variety of pictures.

In the example described above, in case the total added value of the results of multiplications between the band histogram data P0 to Pm and the coefficients 0 to m are within a range of, for example, “1001 to 2000 (hexadecimal”, the analysis control module 45 provides gain values G11 to G1n specified in accordance with ranges in the table shown in FIG. 7 to the corresponding gain control modules 481 to 48n.

On the other hand, depending on where the total added value is in a range of, for example, “1001 to 2000 (hexadecimal)”, that is, at a center section, at a section close to “1001”, at a section close to “2000”, and the like, calculation may be carried out with respect to the gain values G11 to G1n in consideration of gain values that come before and after such gain values. Then, the calculated gain values may be provided to the corresponding gain control modules 481 to 48n.

For example, when a gain value to be provided to the gain control module 481 is considered, the gain control module 481 is provided with a gain value that is obtained by carrying out operation in which, the closer the total added value is to “1001”, the stronger an effect to the original gain value G11 from the gain value G01 that comes before the gain value G11 becomes. In addition, the gain control module 481 is provided with a gain value that remains to be most influenced by the original gain value G11 as the total added value is closer to a center section in a range of “1001 to 2000”. Further, as the total added value is closer to “2000”, a gain value that is obtained by carrying out operation that makes the original gain value G11 more influenced by the gain value G21 that comes after the gain value G11 is provided to the gain control module 481. In this manner, more detailed gain control can be carried out, and an effect of the contour correction can be improved.

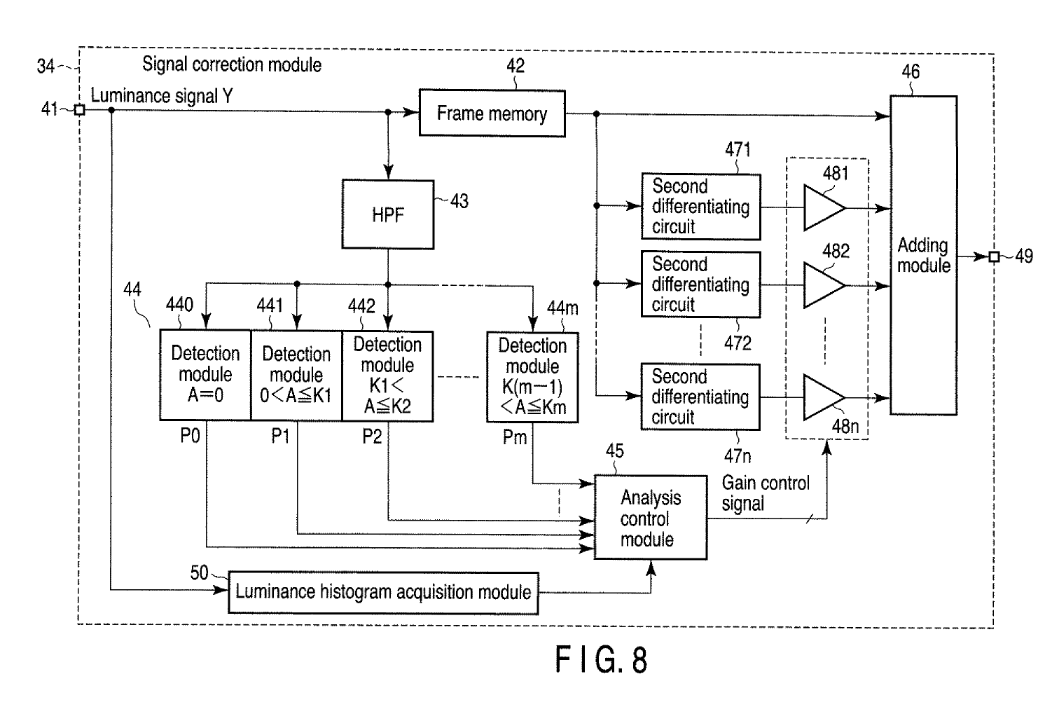

FIG. 8 shows another example of the section that applies the contour correction processing to the luminance signal Y in the signal correction module 34. In FIG. 8, a section that is identical with that in FIG. 3 is attached to with the same reference symbol. The luminance signal Y supplied to the input terminal 41 is supplied to a luminance histogram acquisition module 50 classified by luminance levels. The luminance histogram acquisition module 50 acquires luminance histogram data by counting pixels of one frame of the luminance signal Y according to luminance levels.

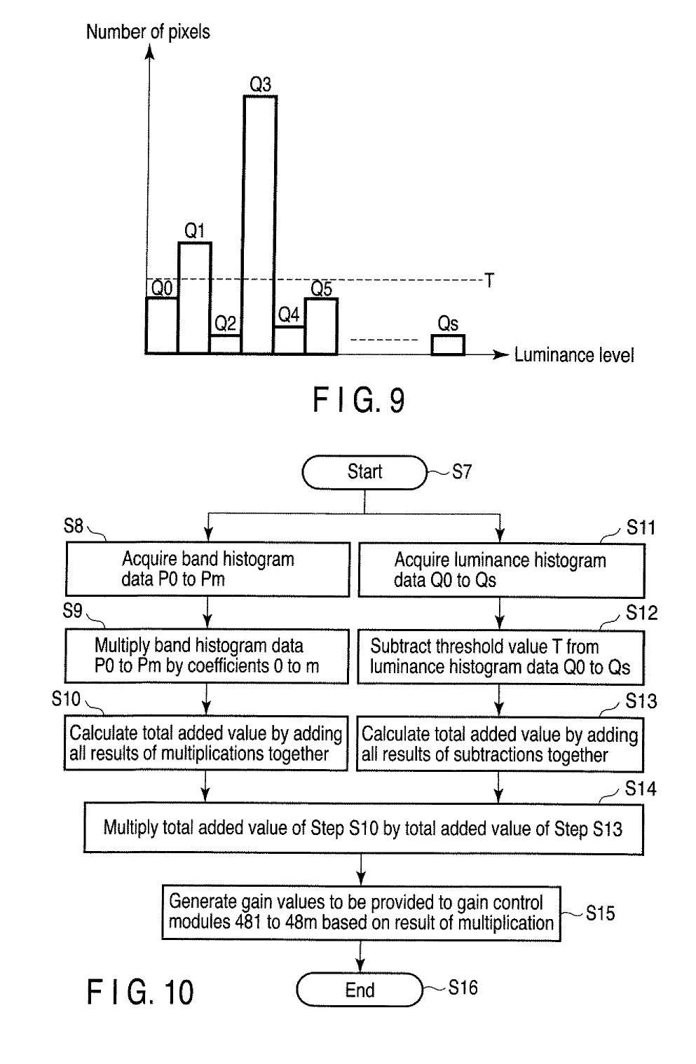

In the above manner, as shown in FIG. 9, the luminance histogram acquisition module 50 can acquire luminance histogram data showing the numbers of pixels Q0 to Qs classified by luminance levels with respect to the one frame of the luminance signal Y. The luminance histogram data acquired by the luminance histogram acquisition module 50 is supplied to the analysis control module 45.

Then, the analysis control module 45 generates gain control signals to be provided to the gain control modules 481 to 48n on the basis of the band histogram data acquired by the band histogram acquisition modules 44 and the luminance histogram data acquired by the luminance histogram acquisition module 50.

FIG. 10 shows a flowchart that organizes an example of processing operation of the analysis control module 45 to generate gain control signals to be provided to the gain control modules 481 to 48n on the basis of the band histogram data acquired by the band histogram acquisition modules 44 and the luminance histogram data acquired by the luminance histogram acquisition module 50.

That is, when the processing starts (Step S7), the analysis control module 45 first acquires band histogram data (the numbers of pixels P0 to Pm) from the detection modules 440 to 44m of the band histogram acquisition modules 44 in Step S8.

Then, in Step S9, the analysis control module 45 multiplies the band histogram data P0 to Pm acquired previously by coefficients set in advance. As the coefficients, for example, 0, 1, 2, . . . , m are set corresponding to the band histogram data P0, P1, P2, . . . , Pm.

In this manner, multiplication processing of P0×0, P1×1, P2×2, . . . , Pm×m, that is, processing of reducing band histogram data corresponding to lower amplitude levels and increasing band histogram data corresponding to higher amplitude levels, is carried out. After the above, in Step S10, the analysis control module 45 calculates a total added value by adding results of all multiplications between the band histogram data PC to Pm and corresponding coefficients 0 to m together.

In addition, when the processing starts (Step S7), in parallel with the processing from Steps S8 to S10, the analysis control module 45 acquires luminance histogram data (the numbers of pixels Q0 to Qs) from the luminance histogram acquisition module 50 in Step S11. Then, in Step S12, the analysis control module 45 subtracts a threshold value T set in advance from the luminance histogram data Q0 to Qs acquired previously. After the above, in Step S13, the analysis control module 45 adds results of all subtractions of the threshold value T from the luminance histogram data Q0 to Qs where luminance histogram data with a subtraction result becoming negative is set to be 0.

Then, in Step S14, the analysis control module 45 multiplies the total added value of results of the multiplications between the band histogram data P0 to Pm and the corresponding coefficients 0 to m obtained in Step S10 by the total added value of results of subtractions of the threshold value T from the luminance histogram data Q0 to Qs in Step s13.

After the above, in Step S15, the analysis control module 45 generates gain values to be provided to the gain control modules 481 to 48n based on a result of the multiplication in Step S14. Then, the analysis control module 45 supplies the generated gain values to the gain control modules 481 to 48n as the gain control signals described above, and the processing ends (Step S16).

In the above case, in the method of generating gain values to be provided to the gain control modules 481 to 48n based on results of the multiplication in Step S14, results of the multiplication in Step S14 are applied to the total added values in the table shown in FIG. 7, so that the gain values to be provided to the gain control modules 481 to 48n can be acquired

According to the contour correction processing means shown in FIG. 8, the total added value of results of subtractions of the predetermined threshold value T from the luminance histogram data Q0 to Qs of one frame of the luminance signal Y is multiplied by the total added value of results of multiplications between the band histogram data P0 to Pm and the coefficients 0 to m.

That is, for example, in case a signal in which a specific wide area in a screen is occupied by a blank section, such as a letter box system and a side panel system, is input as a video signal, a proportion of high frequency components to be applied with the contour correction processing is reduced due to a wide area of the blank section, and a desired contour correction effect is not obtained in several cases.

In view of the above, the total added value of results of subtractions of the predetermined threshold value T from the luminance histogram data Q0 to Qs of one frame of the luminance signal Y, that is, a correction coefficient corresponding to an area of the blank section is prepared. Then, the correction coefficient is multiplied by the total added value of results of multiplications between the band histogram data P0 to Pm and the coefficients 0 to m, so that a sufficient contour correction effect is obtained with respect to high frequency components excluding the blank section.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video signal processing device, comprising:
an input module configured to receive a luminance signal;
an extraction module configured to extract high frequency components from the luminance signal input to the input module;
a band histogram acquisition module configured to acquire band histogram data according to amplitude levels with respect to one frame from the high frequency components of the luminance signal extracted by the extraction module;
a control module configured to apply gain control for contour correction processing based on a gain value provided from outside to the luminance signal input to the input module; and
a generation module configured to generate a gain value to be provided to the control module on the basis of band histogram data acquired by the band histogram acquisition module.

2. The video signal processing device of claim 1, wherein
the generation module comprises an operation module configured to multiplie the band histogram data acquired by the band histogram acquisition module by predetermined coefficients, and calculates a total added value by adding results of all the multiplications together, and
the generation module generates a gain value to be provided to the control module on the basis of a total added value calculated by the operation module.

3. The video signal processing device of claim 2, wherein
the generation module further comprises a table configured to associate the total added value calculated by the operation module with the gain value to be provided to the control module, and
the generation module acquires the gain value to be provided to the control module by referring to the table based on the total added value calculated by the operation module.

4. The video signal processing device of claim 2, wherein
the generation module further comprises:
a table configured to associate the gain value to be provided to the control module with each range of a plurality of ranges that are obtained by classifying values that may be obtained as the total added value calculated by the operation module, and
the generation module checks in which of predetermined ranges in the table the total added value calculated by the operation modules is included, and applies operation processing to a gain value associated with the range in which the total added value is included by including gain values associated with ranges that come before and after the range in which the total added value is included in the operation processing, in order to generate the gain value to be provided to the control module.

5. The video signal processing device of claim 1, further comprising:
a delay module configured to supply the luminance signal input to the input module to the control module after delaying the luminance signal for a period of time required for gain value generation processing by the generation module.

6. The video signal processing device of claim 1, wherein
the control module comprises:
a plurality of differentiating modules configured to extract band components different between each other from the luminance signal input to the input module; and
a plurality of gain control modules configured to apply gain control to contour correction processing based on gain values provided from outside to signals of the band components output from the plurality of differentiating modules, wherein
the generation module generates gain values to be provided to the plurality of gain control modules included in the control module on the basis of the band histogram data acquired by the band histogram acquisition module.

7. The video signal processing device of claim 1, wherein
the generation module comprises a luminance histogram acquisition module configured to acquire luminance histogram data according to luminance levels with respect to one frame from the luminance signal input to the input module, and
the generation module generates a gain value to be provided to the control module on the basis of the band histogram data acquired by the band histogram acquisition module and the luminance histogram data acquired by the luminance histogram acquisition module.

8. The video signal processing device of claim 7, wherein
the generation module comprises:
a first operation module configured to multiply the band histogram data acquired by the band histogram acquisition module by predetermined coefficients, and calculates a total added value by adding results of all the multiplications together; and
a second operation module configured to subtract a predetermined threshold value from the luminance histogram data acquired by the luminance histogram acquisition module, and calculates a total added value by adding results of all the subtractions together, and
the generation module generates gain values to be provided to the control module on the basis of a result of multiplying the total added value calculated by the first operation module by the total added value calculated by the second operation module

9. A video signal processing method comprising:
inputting a luminance signal;
extracting high frequency components from the input luminance signal;
acquiring band histogram data according to amplitude levels with respect to one frame from the extracted high frequency components of the luminance signal;
applying gain control for contour correction processing based on a gain value provided from outside to the input luminance signal; and
generating a gain value for the gain control on the basis of the acquired band histogram data.
